(19) United States
(12) Patent Application Publication
(10) Pub. No.: US 2013/0019584 A1
(43) Pub. Date: Jan. 24, 2013

(54) BURNER, GAS TURBINE COMBUSTOR, BURNER COOLING METHOD, AND BURNER MODIFYING METHOD

(71) Applicant: Hitachi, Ltd., Tokyo (JP)

(72) Inventors: Hiromi Koizumi, Hitachi (JP); Hiroshi Inoue, Mito (JP); Toshifumi Sasao, Mito (JP); Isao Takehara, Hitachi (JP)

(73) Assignee: HITACHI, LTD., Tokyo (JP)

(21) Appl. No.: 13/627,565

(22) Filed: Sep. 26, 2012

Related U.S. Application Data
(62) Division of application No. 11/473,062, filed on Jun. 23, 2006.

(30) Foreign Application Priority Data
Jun. 24, 2005 (JP) 2005-184983
Jun. 19, 2006 (JP) 2006-168987

(51) Int. Cl. F02C 3/20; F23R 3/12; F02C 7/26; F02C 3/22

(52) U.S. Cl. 60/39.465; 60/39.463; 60/748; 60/786

(57) ABSTRACT

In a burner for injecting mixed gas fuel containing at least one of hydrogen and carbon monoxide into a combustion chamber of a gas turbine combustor, the burner includes a fuel nozzle for startup from which liquid fuel is injected into the combustion chamber, and a mixed fuel nozzle disposed around the fuel nozzle for injecting the mixed gas fuel. An air swirler is disposed at a downstream end of the mixed fuel nozzle and has a plurality of flow passages from which compressed air is injected into the combustion chamber, and the mixed fuel nozzle has injection ports disposed in the inner peripheral side of the flow passages of the air swirler. Cooling holes formed in the nozzle surface and positioned to face the combustion chamber introduce a part of the mixed gas fuel injected from the mixed fuel nozzle into the combustion chamber.

### BACKGROUND OF THE INVENTION

1. Field of the Invention

The present invention relates to a burner using mixed fuel containing at least one of hydrogen and carbon monoxide, and also relates to a gas turbine combustor, a burner cooling method, and a burner modifying method.

2. Description of the Technology

Recently, the varieties of fuel for use in gas turbines have been increased. The use of multi-component mixed gas fuel containing hydrogen, carbon monoxide, etc. (hereinafter referred to simply as “mixed fuel”) has been proposed in addition to conventional primary fuel for gas turbines, such as LNG (liquefied natural gas), light oil, and A-heavy oil. Such mixed fuel has a higher flame temperature than LNG. In particular, hydrogen has a wider flammable range and a faster burning velocity and is easy to burn.

LNG is burned primarily by employing a premixed combustion system. However, when the mixed fuel is burned by employing the premixed combustion system, flashback is apt to occur due to change of combustion characteristics caused by change of fuel composition and the presence of hydrogen and/or carbon oxide in the mixed fuel. It is therefore difficult to burn the mixed fuel by employing the premixed combustion system. For that reason, the mixed fuel is generally burned by a burner employing a diffusive combustion system in which fuel and air are separately injected into a combustion chamber (see, e.g., Patent Document 1: JP,A 2004-3730).

### SUMMARY OF THE INVENTION

In the case of using the mixed fuel containing hydrogen, even when the mixed fuel is burned in a manner of diffusive combustion, due care has to be paid to safety at the time of ignition in a gas turbine. It is hence desired that another kind of fuel, e.g., light oil, be used at the startup of the gas turbine. When another kind of fuel, e.g., light oil, is used to start up the gas turbine, the operating mode is shifted from a mode using fuel for the startup to a gas combustion mode using only the mixed fuel after the steps of startup, acceleration and application of load. Herein, the term “gas combustion mode” means the operating mode in which only the mixed fuel is supplied to a combustor. However, after the shift to the gas combustion mode using only the mixed fuel, there is a fear that a flame may become apt to come close to a nozzle surface and metal temperature at the nozzle surface may rise excessively because the mixed fuel has a higher flame temperature and a faster burning velocity.

An object of the present invention is to provide a burner, a gas turbine combustor, a burner cooling method, and a burner modifying method, which can hold metal temperature at a nozzle surface within a proper range and can increase reliability even when mixed fuel containing at least one of hydrogen and carbon monoxide is used as fuel.

(1) To achieve the above object, the present invention provides a burner for injecting mixed fuel containing at least one of hydrogen and carbon monoxide into a combustion chamber of a gas turbine combustor, wherein the burner comprises a fuel nozzle for startup from which fuel for startup is injected into the combustion chamber; a mixed fuel nozzle disposed around the fuel nozzle for startup and injecting the mixed fuel; an air swirler disposed at a downstream end of the mixed fuel nozzle positioned in the combustion chamber and having a plurality of flow passages through which a part of compressed air from a compressor is injected into the combustion chamber to hold a flame, the mixed fuel nozzle having injection ports disposed in the inner peripheral side of the flow passages of the air swirler; and cooling holes formed in a nozzle surface positioned to face the combustion chamber and introducing a part of the mixed fuel injected from the mixed fuel nozzle into the combustion chamber, to thereby reduce flame temperature near the nozzle surface.

(2) In above (1), preferably, the fuel nozzle for startup comprises a liquid fuel nozzle for injecting liquid fuel for the startup of the gas turbine, and an atomizing air nozzle disposed around the liquid fuel nozzle and injecting atomizing air to atomize the liquid fuel.

(3) In above (1), preferably, the fuel nozzle for startup is disposed at a center of a combustion liner forming the combustion chamber in the radial direction.

(4) In above (1), preferably, the burner further comprises an inert gas supply system for supplying inert gas to the fuel nozzle for startup, wherein the inert gas from the inert gas supply system is supplied to the fuel nozzle for startup such that the inert gas is injected to the vicinity of the nozzle surface from the fuel nozzle for startup during a gas combustion mode using only the mixed fuel.

(5) In above (1), preferably, the mixed fuel is any of coke oven gas, blast furnace gas, LD gas, coal, and heavy oil gasification gas.

(6) Also, to achieve the above object, the present invention provides a gas turbine combustor for burning mixed fuel containing at least one of hydrogen and carbon monoxide, wherein the combustor comprises an outer casing serving as a pressure vessel; a combustion liner disposed inside the outer casing and forming a combustion chamber therein; a burner for forming a flame in the combustion chamber within the combustion liner; and a transition piece for introducing, to a burner, the burned gas generated with the formation of the flame by the burner, the burner comprising a fuel nozzle for startup from which fuel for startup is injected into the combustion chamber; a mixed fuel nozzle disposed around the fuel nozzle for startup and injecting the mixed fuel; an air swirler disposed at a downstream end of the mixed fuel nozzle positioned in the combustion chamber and having a plurality of flow passages through which a part of compressed air from a compressor is injected into the combustion chamber to hold a flame, the mixed fuel nozzle having injection ports disposed in the inner peripheral side of the flow passages of the air swirler; and cooling holes formed in a nozzle surface positioned to face the combustion chamber and introducing a part of the mixed fuel injected from the mixed fuel nozzle into the combustion chamber, to thereby reduce flame temperature near the nozzle surface.

(7) Further, to achieve the above object, the present invention provides a method of cooling a burner employing a diffusive combustion system and injecting mixed fuel containing at least one of hydrogen and carbon monoxide into a combustion chamber of a gas turbine combustor, wherein the method comprises the steps of forming cooling holes in a nozzle surface positioned to face the combustion chamber such that a part of the mixed fuel is injected through the cooling holes; and injecting the part of the mixed fuel into the combustion chamber through the cooling holes, to thereby reduce flame temperature near the nozzle surface and suppress a rise of metal temperature at the nozzle surface.

(8) Still further, to achieve the above object, the present invention provides a burner for injecting mixed fuel containing at least one of hydrogen and carbon monoxide into a combustion chamber of a gas turbine combustor, wherein the burner comprises a fuel nozzle for startup which comprises a liquid fuel nozzle for injecting liquid fuel for the startup of the gas turbine, and an atomizing air nozzle disposed around the liquid fuel nozzle and injecting atomizing air to atomize the liquid fuel; a mixed fuel nozzle disposed around the fuel nozzle for startup and injecting the mixed fuel; an air swirler disposed at a downstream end of the mixed fuel nozzle positioned in the combustion chamber and injecting a part of compressed air from a compressor into the combustion chamber to hold a flame; and an inert gas supply system for supplying inert gas to the fuel nozzle for startup, the inert gas from the inert gas supply system being supplied to the fuel nozzle for startup such that the inert gas is injected to the vicinity of a nozzle surface from the fuel nozzle for startup during a gas combustion mode using only the mixed fuel.

(9) Still further, to achieve the above object, the present invention provides a gas turbine combustor for burning mixed fuel containing at least one of hydrogen and carbon monoxide, wherein the combustor comprises an outer casing serving as a pressure vessel; a combustion liner disposed inside the outer casing and forming a combustion chamber therein; a burner for forming a flame in the combustion chamber within the combustion liner; and a transition piece for introducing, to a turbine, burned gas generated with the formation of the flame by the burner, the burner comprising a fuel nozzle for startup which comprises a liquid fuel nozzle for injecting liquid fuel for the startup of the gas turbine, and an atomizing air nozzle disposed around the liquid fuel nozzle and injecting atomizing air to atomize the liquid fuel; a mixed fuel nozzle disposed around the fuel nozzle for startup and injecting the mixed fuel; an air swirler disposed at a downstream end of the mixed fuel nozzle positioned in the combustion chamber and injecting a part of compressed air from a compressor into the combustion chamber to hold a flame; and an inert gas supply system for supplying inert gas to the fuel nozzle for startup, the inert gas from the inert gas supply system being supplied to the fuel nozzle for startup such that the inert gas is injected to the vicinity of a nozzle surface from the fuel nozzle for startup during a gas combustion mode using only the mixed fuel.

(10) Still further, to achieve the above object, the present invention provides a method of cooling a burner employing a diffusive combustion system and injecting mixed fuel containing at least one of hydrogen and carbon monoxide into a combustion chamber of a gas turbine combustor, wherein the method comprises the steps of providing a mixed fuel nozzle for injecting the mixed fuel to be disposed around a fuel nozzle for startup from which fuel for startup is injected into the combustion chamber; and supplying inert gas from an inert gas supply system to the fuel nozzle for startup such that the inert gas is injected to the vicinity of a nozzle surface from the fuel nozzle for startup during a gas combustion mode using only the mixed fuel, thereby reducing flame temperature near the nozzle surface and suppressing a rise of metal temperature at the nozzle surface.

(11) Still further, to achieve the above object, the present invention provides a burner for injecting mixed fuel containing at least one of hydrogen and carbon monoxide into a combustion chamber of a gas turbine combustor, wherein the burner comprises a fuel nozzle for startup from which fuel for startup is injected into the combustion chamber; a mixed fuel nozzle disposed around the fuel nozzle for startup and injecting the mixed fuel; an air swirler disposed at a downstream end of the mixed fuel nozzle positioned in the combustion chamber and having a plurality of flow passages through which a part of compressed air from a compressor is injected into the combustion chamber to hold a flame, the mixed fuel nozzle having injection ports disposed in the inner peripheral side of the flow passages of the air swirler; and a unit for purging the fuel residing in the fuel nozzle for startup.

(12) In above (11), preferably, the unit for purging the fuel includes a system for supplying a part of the mixed fuel, which is supplied to the mixed fuel nozzle, to the fuel nozzle for startup.

(13) Still further, to achieve the above object, the present invention provides a burner for injecting mixed fuel containing at least one of hydrogen and carbon monoxide into a combustion chamber of a gas turbine combustor, wherein the burner comprises a fuel nozzle for startup from which fuel for startup is injected into the combustion chamber; a mixed fuel nozzle disposed around the fuel nozzle for startup and injecting the mixed fuel; a swirler disposed to face the combustion chamber and including an air swirler disposed at a downstream end of the mixed fuel nozzle positioned in the combustion chamber and having a plurality of flow passages through which a part of compressed air from a compressor is injected into the combustion chamber to hold a flame, the mixed fuel nozzle having injection ports disposed in the inner peripheral side of the flow passages of the air swirler; and a unit for reducing flame temperature in the vicinity of the swirler disposed to face the combustion chamber to be lower than the melting point of a swirler material.

(14) Still further, to achieve the above object, the present invention provides a method of modifying a burner for injecting mixed fuel containing at least one of hydrogen and carbon monoxide into a combustion chamber of a gas turbine combustor, the burner comprising a fuel nozzle for startup which comprises a liquid fuel nozzle for injecting liquid fuel for the startup of the gas turbine, and an atomizing air nozzle disposed around the liquid fuel nozzle and injecting atomizing air to atomize the liquid fuel; a mixed fuel nozzle disposed around the fuel nozzle for startup and injecting the mixed fuel; and a plurality of flow passages which are formed in a downstream end of the mixed fuel nozzle positioned in the combustion chamber and through which a part of compressed air from a compressor is injected into the combustion chamber to hold a flame, wherein the method includes the step of additionally providing, on the burner, a unit for supplying inert gas to the atomizing air nozzle.

According to the present invention, even when the mixed fuel containing at least one of hydrogen and carbon monoxide is used as fuel, the flame temperature can be reduced by increasing a fuel concentration near the nozzle surface, whereby the metal temperature at the nozzle surface can be held within a proper range and reliability can be increased. In addition, the metal temperature at the nozzle surface can also be held within the proper range by supplying inert gas to the vicinity of the nozzle surface.

### BRIEF DESCRIPTION OF THE DRAWINGS

FIG. 1 is a schematic view of a gas turbine plant equipped with a burner related to a first embodiment of the present invention;

FIG. 2 is a partial enlarged side sectional view of the burner related to a first embodiment of the present invention;

FIG. 3 is a front view, looking from the combustion chamber side, of the burner related to the first embodiment of the present invention;

FIG. 4 is a partial enlarged side sectional view of a burner related to a second embodiment of the present invention;

FIG. 5 is a front view, looking from the combustion chamber side, of the burner related to the second embodiment of the present invention;

FIG. 6 is a schematic view of a gas turbine plant equipped with the burner related to the second embodiment of the present invention;

FIG. 7 is a graph showing the relationship between a mass flow ratio of fuel (mixed gas of hydrogen, methane and nitrogen) to air and adiabatic flame temperature;

FIG. 8 is a graph showing the correlation between supply of atomizing air and inert gas and metal temperature at a nozzle surface after a shift to a gas combustion mode using only the mixed fuel; and

FIG. 9 is a schematic view showing a system for purging liquid fuel residing in a nozzle for startup.

### DESCRIPTION OF THE PREFERRED EMBODIMENTS

Embodiments of the present invention will be described below with reference to the drawings.

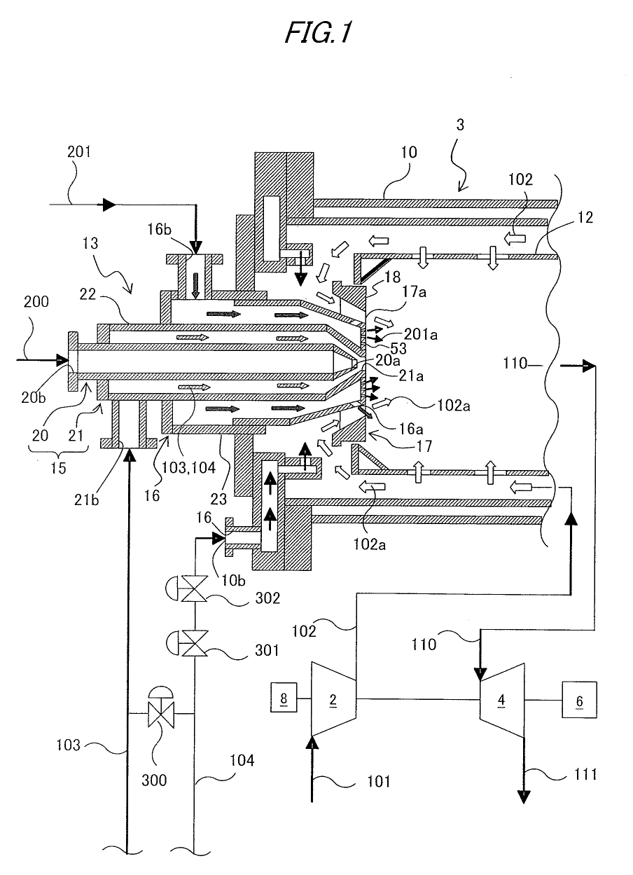

FIG. 1 is a schematic view of a gas turbine plant equipped with a burner related to a first embodiment of the present invention.

The gas turbine plant equipped with the burner related to this first embodiment comprises an air compressor 2, a combustor 3, a turbine 4, a generator 6, a startup motor 8 for driving a gas turbine, and so on. Inlet air 101 is compressed in the air compressor 2, and compressed air 102 from the air compressor 2 is burned in the combustor 3 together with fuel 200 and 201. When burned gas 110 from the combustor 3 is supplied to the turbine 4, the turbine 4 produces torque with the burned gas 110, and the torque produced by the turbine 4 is transmitted to both the air compressor 2 and the generator 6. The torque transmitted to the air compressor 2 is used as power for compressing air, and the torque transmitted to the generator 6 is converted to electrical energy.

While the generator 6 is shown as being load equipment in FIG. 1, a pump, etc. may also be used as the load equipment. Further, the turbine 4 is not limited to the one-shaft type, and it may be of the two-shaft type.

The combustor 3 in this first embodiment burns multi-component mixed gas fuel (hereinafter referred to simply as “mixed fuel”) containing at least one of hydrogen (H₂) and carbon monoxide (CO). The gas turbine plant includes supply systems for supplying not only gas fuel 201, i.e., the mixed fuel, but also liquid fuel 200 used as fuel for startup of the gas turbine, atomizing air 103 for atomizing the liquid fuel 200, and inert gas (steam) 104 necessary for reducing NOx. The gas fuel 201 burned in the combustor 3 is, for example, multi-component gas fuel such as coke oven gas, blast furnace gas and LD gas, or coal containing hydrogen and carbon monoxide which are obtained by gasifying coal, heavy oil and other materials with the aid of oxygen, or heavy oil gasification gas. The liquid fuel 200 is, for example, light oil or A-heavy oil.

The combustor 3 comprises an outer casing 10 working as a pressure vessel, a combustion liner 12 disposed inside the outer casing 10 and forming a combustion chamber therein, a burner 13 for forming a flame in the combustion chamber within the combustion liner 12, and a transition piece (not shown) for introducing, to the turbine 4, the burned gas 110 generated with the formation of the flame by the burner 13. In this first embodiment, the burner 13 employs a diffusive combustion system and is provided one for each unit of the combustor.

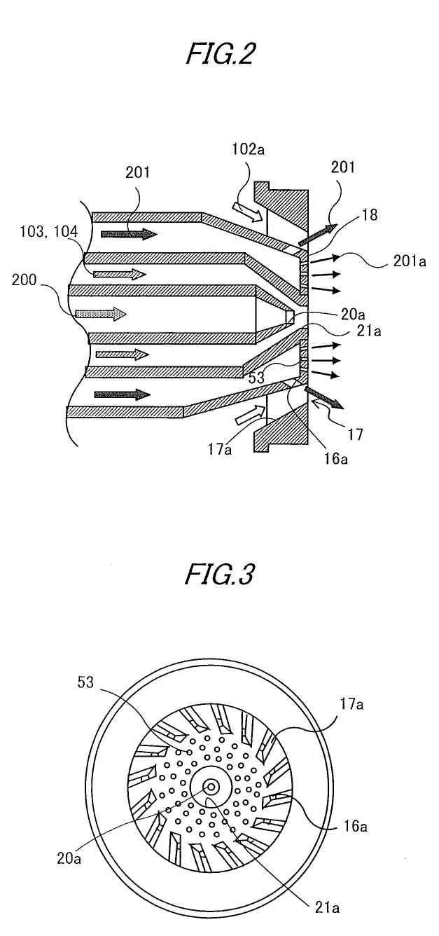

FIG. 2 is a partial enlarged side sectional view of the burner 13, and FIG. 3 is a front view, looking from the combustion chamber side, of the burner 13.

As shown in FIGS. 1, 2 and 3, the burner 13 comprises a fuel nozzle 15 for startup from which the liquid fuel 200 used as the fuel for startup is injected into the combustion chamber, a mixed fuel nozzle 16 for injecting the gas fuel 201, and an air swirler 17 for injecting a part 102a of the compressed air 102 from the air compressor 2 into the combustion chamber in order to hold the flame.

The fuel nozzle 15 for startup is disposed at a center of the combustion chamber in the radial direction, and it comprises a liquid fuel nozzle 20 for injecting the liquid fuel 200 for the startup of the gas turbine, and an atomizing air nozzle 21 for injecting the atomizing air 103 to atomize the liquid fuel 200. The atomizing air nozzle 21 is formed by an inner casing 22 disposed so as to surround the liquid fuel nozzle 20. The atomizing air 103 and the inert gas (steam) 104 flow through a flow passage formed between an inner wall surface of the liner 22 and an outer wall surface of the liquid fuel nozzle 20. The atomizing air 103 and the inert gas (steam) 104 both injected through an injection port 21a of the atomizing air nozzle 21, which is positioned to face the combustion chamber, interfere with the liquid fuel 200 injected through an injection port 20a of the liquid fuel nozzle 20. As a result, the liquid fuel 200 is atomized and injected into the combustion chamber.

The mixed fuel nozzle 16 has a main body, i.e., a body 23, disposed so as to surround the atomizing air nozzle 21. The gas fuel 201 flows through a flow passage formed between an inner wall surface of the body 23 and an outer wall surface of the inner casing 22 of the atomizing air nozzle 21. The air swirler 17 is disposed at a downstream end of the mixed fuel nozzle 16 positioned in the combustion chamber. As shown in FIGS. 2 and 3, the air swirler 17 has a plurality of flow passages 17a formed at constant intervals in the circumferential direction so that a swirl component is given to the compressed air 102a. The flow passages 17a are formed to radially obliquely extend with respect to an outer circumference of the body 23 on the side close to the combustion chamber. A part 102a of the compressed air 102 supplied from the air compressor 2 to the combustor 3 is introduced to the flow passages 17a of the air swirler 17 by the action of pressure balance. The remaining compressed air 102 flows into the combustion chamber through combustion air holes and cooling holes which are formed in the combustion liner 12. Accordingly, the combustion liner 12 can be cooled by the compressed air from the air compressor 2 at the same time.

Injection ports 16a of the mixed fuel nozzle 16 are disposed at the inner peripheral side of the flow passage 17a of the air swirler 17 such that the gas fuel 201 injected through the injection ports 16a is introduced into the combustion chamber together with the swirl flow injected from the air swirler 17. Thus, the swirled compressed air 102a from the air swirler 17 and the gas fuel 201 are mixed, whereby the flame is held in front of the air swirler 17.

Cooling holes 53 are formed in a nozzle surface (swirler surface) 18 of the burner 13, which is positioned to face the combustion chamber. The cooling holes 53 are formed in large numbers in a region between the injection port 21a of the atomizing air and the flow passages 17a of the air swirler 17 to be communicated with a flow passage of the mixed fuel nozzle 16. A part 201a of the gas fuel 201 injected from the mixed fuel nozzle 16 is introduced into the combustion chamber through the cooling holes 53. As a result, the fuel concentration near the nozzle surface 18 is enriched.

In this first embodiment, there are independently provided a startup fuel supply system for supplying the liquid fuel 200 to the fuel nozzle 15 for startup, and a mixed fuel supply system for supplying the gas fuel 201 to the mixed fuel nozzle 16. The startup fuel supply system is connected to an inlet port 20b of the liquid fuel nozzle 20, and the mixed fuel supply system is connected to an inlet port 16b of the mixed fuel nozzle 16. Each of those supply systems includes a control valve (not shown) for adjusting a fuel mass flow.

On the other hand, an atomizing air supply system for supplying the atomizing air 103 to the atomizing air nozzle 21 is connected to an inlet port 21b of the atomizing air nozzle 21, and an inert gas supply system for supplying the inert gas 104 to the air swirler 17 is connected to an inlet port 10b of the combustor outer casing 10. The atomizing air supply system and the inert gas supply system are connected to each other through a bypass line. In the bypass line interconnecting those two supply systems, a shutoff valve 300 is disposed to selectively open and close a flow passage of the bypass line. Further, in a portion of the inert gas supply system downstream of the bypass line, a shutoff valve 301 for selectively opening and closing a flow passage of the inert gas supply system and a steam flow control valve 302 for adjusting a mass flow of the steam flowing through the inert gas supply system are disposed in this order from the upstream side.

At the startup of the gas turbine plant constructed as described above, the gas turbine is driven by an external motive power supplied from, e.g., the startup motor 8 and ignition is started in the combustor 3 by using the compressed air 102 discharged from the air compressor 2 and the liquid fuel 200. The burned gas 110 from the combustor 3 is supplied to the turbine 4 so that torque is given to the turbine 4. As the mass flow of the liquid fuel 200 increases, the rotational speed of the turbine 4 is increased, and by stopping the startup motor 8, the gas turbine is shifted to a self-sustaining operation. When the rotational speed of the turbine 4 reaches a non-load rated speed, the generator 6 is brought into operation and the mass flow of the liquid fuel 200 is further increased, whereby the inlet gas temperature in the turbine 4 rises and a load is increased.

After application of the load, the steam 104 is injected into the combustor 3 from the inert gas supply system to suppress the amount of NOx emission. The steam 104 supplied to the combustor 3 passes through the shutoff valve 301 and is adjusted to a proper mass flow by the steam flow control valve 302. Then, the steam 104 is mixed with the combustion air 102a from the air compressor 2 and is injected into the combustion chamber through the flow passages 17a of the air swirler 17. The oxygen concentration of the combustion air 102a is reduced after being mixed with the steam 104. As a result, since the liquid fuel 200 is burned with air having the reduced oxygen concentration, the flame temperature in the combustion chamber lowers and the NOx emission is suppressed.

After a subsequent operation of increasing the load, it becomes possible to perform a fuel changeover operation from the liquid fuel 200 to the gas fuel 201, i.e., the mixed gas fuel. The fuel changeover operation is to decrease the mass flow of the liquid fuel 200 and to increase the feed rate of the gas fuel 201 while the load of the gas turbine is kept constant. Finally, when the fuel changeover operation from the liquid fuel 200 to the gas fuel 201 is completed and the operating mode is shifted to a gas combustion mode using only the mixed fuel, the load can be further increased with an increase in the mass flow of the gas fuel 201. After the shift to the gas combustion mode using only the mixed fuel, the supply of the liquid fuel 200 is stopped and then the supply of the atomizing air 103 for atomizing the liquid fuel 200 is also stopped.

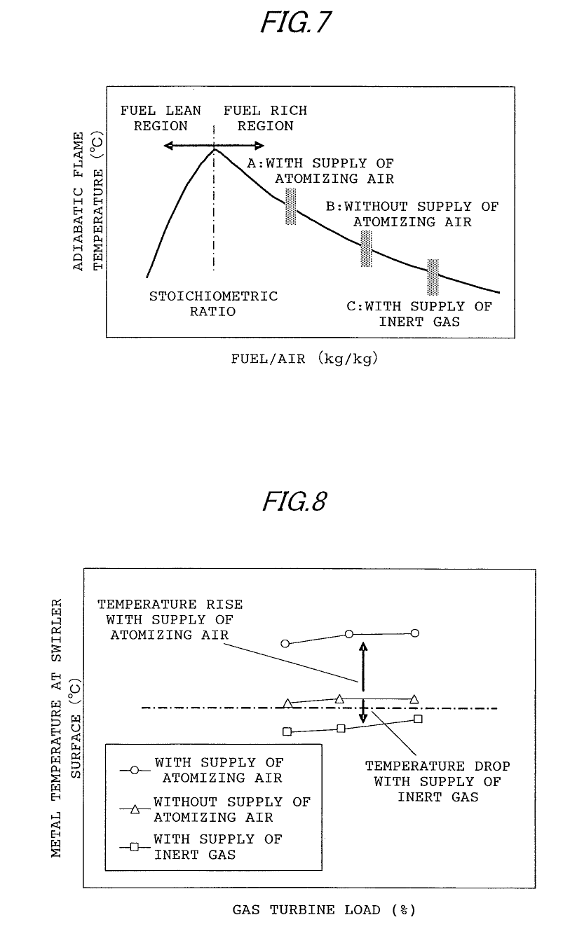

In the burner for the diffusive combustion as in this first embodiment, air is usually injected from the downstream nozzle surface of the burner positioned in the combustion chamber so that the fuel for startup is atomized. However, the supply of air for that purpose affects the metal temperature at the nozzle surface to a large extent when the multi-component mixed gas is burned. The reasons will be described below with reference to FIGS. 7 and 8.

FIG. 7 is a graph showing the relationship between a mass flow ratio (F/A) of fuel (mixed gas of hydrogen, methane and nitrogen) to air and adiabatic flame temperature.

As shown in FIG. 7, the adiabatic flame temperature (° C.) has such a tendency to rise as F/A (kg/kg) is increased, to maximize at a certain F/A condition, and thereafter to lower gradually when F/A is further increased. The F/A at which the adiabatic flame temperature is maximized is called a stoichiometric ratio. Also, the region in which F/A is lower than that ratio is called a fuel lean region, and the region in which F/A is higher than that ratio is called a fuel rich region. Considering the behavior of F/A in the fuel rich region, the F/A value comes closer to the stoichiometric ratio when the atomizing air is supplied (area A in FIG. 7) than that when the atomizing air is not supplied (area B in FIG. 7).

In this first embodiment, it deems that the fuel rich region is formed near the nozzle surface of the combustor 3. With the supply of the atomizing air, F/A comes closer to the stoichiometric ratio and the flame temperature (combustion temperature) rises. On the other hand, when the inert gas, e.g., steam, is supplied, the adiabatic flame temperature tends to lower (area C in FIG. 7).

FIG. 8 is a graph showing the correlation between the supply of the atomizing air and the inert gas and the metal temperature at the nozzle surface after the shift to the gas combustion mode using only the mixed fuel.

FIG. 8 represents the case where the mixed gas of hydrogen, methane and nitrogen is burned. As shown in FIG. 8, regardless of the load condition of the gas turbine, the metal temperature is higher when the atomizing air is supplied than that when the atomizing air is not supplied, and the metal temperature is lower when the inert gas is supplied than that when the inert gas is not supplied. This is presumably attributable to the fact that F/A near the nozzle surface is changed and the combustion temperature is also changed depending on the atomizing air and the inert gas supply. In the case of using the mixed fuel containing hydrogen and carbon monoxide, particularly, because the flame tends to approach the nozzle surface because of a higher burning velocity, the metal temperature is more strongly affected by the flame temperature. Accordingly, when the mixed fuel containing hydrogen and carbon monoxide is burned as in this first embodiment, a rise of the metal temperature at the nozzle surface can be suppressed by paying consideration such that F/A near the nozzle surface does not satisfy the condition providing the value of F/A in the vicinity of the stoichiometric ratio.

In this embodiment using the mixed fuel, if the nozzle surface is cooled by employing a part of the air discharged from the compressor, F/A comes closer to the stoichiometric ratio and the flame temperature rises. Therefore, when the mixed fuel containing hydrogen and/or carbon monoxide is burned, it is difficult to cool the nozzle surface by employing air because the flame approaches the swirler and the metal temperature is apt to rise. Also, if F/A near the nozzle surface is set to fall within the fuel lean region, for example, by increasing the amount of air supplied to the air swirler 17, this method is not practical for the reason that unburned hydrogen is increased and blow-off is apt to occur under low-load conditions where the fuel mass flow is reduced. Conversely, if F/A near the nozzle surface is increased by extremely reducing the amount of air supplied to the air swirler 17, this method gives rise to another problem in flame stability, e.g., blowout, because F/A decreases in the fuel rich region beyond a flammable range.

In contrast, according to this first embodiment, since the cooling holes 53 for introducing a part of the mixed gas fuel 201 are formed in the nozzle surface, the fuel concentration near the nozzle surface is enriched. Therefore, F/A in an area near the nozzle surface can be increased and the flame temperature near the nozzle surface can be reduced. It is hence possible to avoid a phenomenon of an increase in the flame temperature, which is caused due to a shift of F/A toward the stoichiometric ratio in the case of air cooling, and to lower the metal temperature at the nozzle surface.

Although the temperature of fuel supplied to the gas turbine differs to some extent depending on the kind of fuel, the temperature of coke oven gas or the like is not higher than 100° C. and the temperature of gasification gas obtained by gasifying coal with the aid of oxygen is not higher than 200-300° C. Those temperatures are lower than the temperature (about 390° C.) of the air discharged from the compressor (i.e., the compressor discharge temperature). Therefore, a higher cooling capability than that in the case of air cooling can be obtained by utilizing sensible heat of the fuel. Thus, the metal temperature at the nozzle surface can be held within a proper range while ensuring combustion stability within a working load range of the gas turbine, whereby reliability can be improved.

Further, according to this first embodiment, since the injection ports 16a for the gas fuel 201 are formed at the inner peripheral side of the flow passages 17a of the air swirler 17, the injection ports 16a are subjected to the dynamic pressure of the compressed air 102a. During the operation using only the liquid fuel 200, therefore, the compressed air 102a from the air compressor 2 is supplied to the mixed fuel nozzle 16 through the injection ports 16a, and then the compressed air 102a is introduced into the combustion chamber through the cooling holes 53 formed in the nozzle surface. At that time, the injected liquid fuel 200 and the compressed air 102a introduced through the cooling holes 53 are mixed. In comparison with the case where the liquid fuel 200 is mixed with only the compressed air 102a supplied from the air swirler 17, therefore, a larger amount of air is supplied to the fuel nozzle 15 for startup, and this is more effective in suppressing soot generated during the combustion of the liquid fuel.

Generally, liquid fuel is burned through processes of atomization of the liquid fuel, vaporization of the atomized fuel, mixing of the vaporized fuel and air, and combustion. Therefore, if the mixing of the fuel and air is insufficient, the carbonaceous concentration, such as soot, is increased during the combustion. In this first embodiment, the compressed air 102a is supplied through the cooling holes 53 for introducing the gas fuel 201 in the vicinity of an atomizing sheath (injection hole 21a) through which the liquid fuel for startup is injected while being atomized. This leads to an additional advantage of suppressing the generation of soot, which is caused with combustion of the liquid fuel.

In addition, according to this first embodiment, by opening the shutoff valve 300, a part of the inert gas 104, e.g., steam, which is used to reduce NOx, can be supplied to the atomizing air supply system constituted by the fuel nozzle 15 for startup. The steam 104 required for reducing NOx is supplied after the operating mode is shifted to the gas combustion mode using only the gas fuel 201 and the supply of the atomizing air 103 is stopped. Since the flame temperature near the nozzle surface lowers (see also FIG. 7) by injecting the steam 104 through the fuel nozzle 15 for startup, which is disposed at the center of the nozzle surface, the metal temperature at the nozzle surface can be reduced.

Further, a check valve has to be disposed in the atomizing air supply system to prevent backflow of the steam 104 when the steam 104 is supplied to the fuel nozzle 15 for startup. While the first embodiment has been described, by way of example, in connection with the case of employing steam to reduce NOx, it is also possible to employ another kind of inert gas, e.g., nitrogen or carbon dioxide, which is generally obtained in the gas turbine plant. Such a case can also provide similar advantages to those described above.

Moreover, after burning the liquid fuel 200, by injecting the inert gas through the fuel nozzle 15 for startup through the supply system for the atomizing air 103 which is here utilized as the inert gas supply system, triple fuel of oil, atomizing air, and gas can be supplied with a simpler structure.

While the above-described embodiment includes both the structure for injecting the gas fuel 201 through the cooling holes 53 and the structure for injecting the inert gas from the atomizing air supply system for the fuel nozzle 15 for startup, a high cooling effect can also be obtained with either one of those two structures. When the function of cooling the nozzle surface by injecting the inert gas through the center of the nozzle surface is omitted, for example, it is just required to omit the shutoff valve 300 and the bypass line in which the shutoff valve 300 is disposed. Conversely, when the cooling function obtained by injecting the mixed fuel through the cooling holes 53 is omitted, the effect of cooling the nozzle surface can be obtained by injecting the inert gas through the center of the nozzle surface.

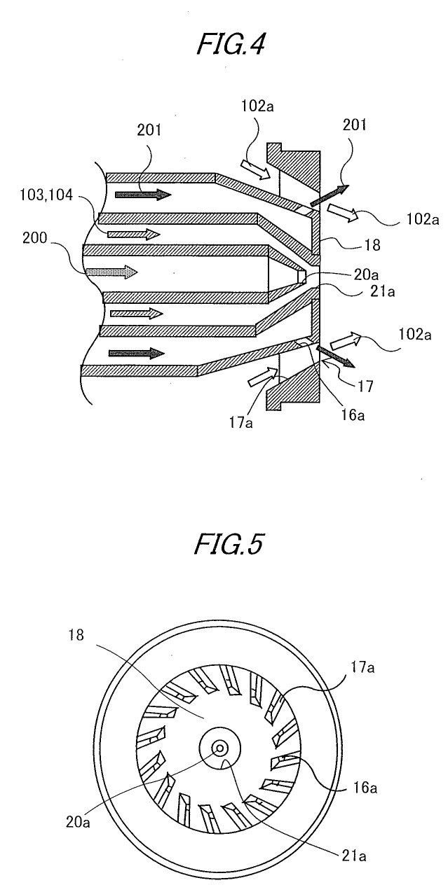

FIG. 4 is a partial enlarged side sectional view of a burner according to a second embodiment of the present invention, in which the cooling holes 53 in the first embodiment are omitted, and FIG. 5 is a front view, looking from the combustion chamber side, of the burner according to the second embodiment. In FIGS. 4 and 5, similar components to those in FIGS. 1, 2 and 3 are denoted by the same reference numerals and a description of those components is omitted here.

In the burner shown in FIGS. 4 and 5, the injection ports 16a are formed at the inner peripheral side of the flow passages 17a of the air swirler 17, and the fuel nozzle 15 for startup is disposed at the center of the air swirler 17 in the radial direction. Stated another way, the burner according to the second embodiment has the same structure as that shown in FIGS. 2 and 3 except for that the cooling holes 53 are omitted. A rise of the metal temperature at the nozzle surface 18 can also be suppressed even with the burner having the structure that the cooling holes 53 are not formed and the fuel concentration in the area near the nozzle surface 18 cannot be enriched with the absence of the cooling holes 53 for introducing a part of the gas fuel.

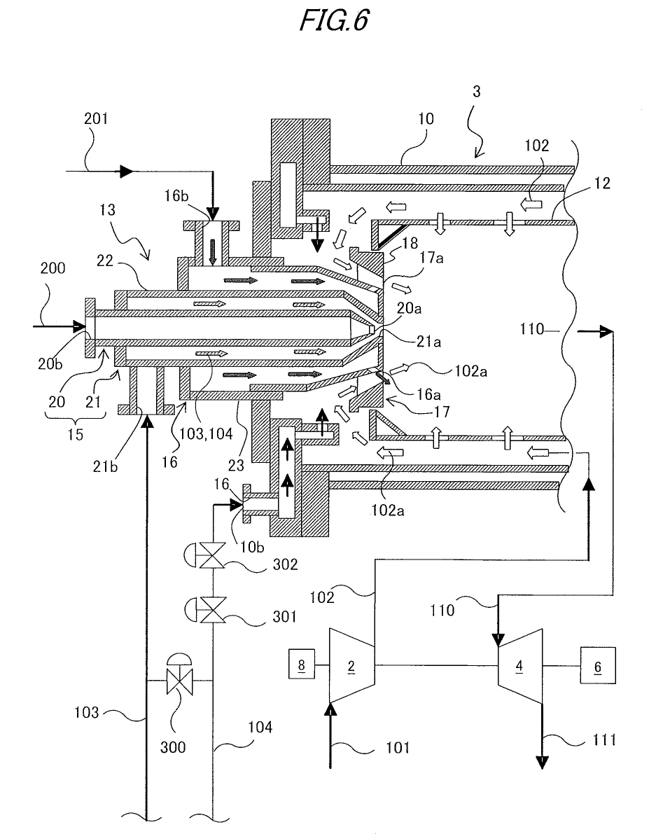

FIG. 6 is a schematic view of a gas turbine plant equipped with the burner, shown in FIGS. 4 and 5, according to the second embodiment of the present invention.

As in the gas turbine plant shown in FIG. 1, the gas turbine plant shown in FIG. 6 employs the gas fuel 201 made of a multi-component gas containing hydrogen and/or carbon monoxide, the liquid fuel 200 serving as the fuel for the startup of the gas turbine, the atomizing air 103 for atomizing the liquid fuel 200, and the steam (inert gas) 104 for reducing NOx. Also, as in the gas turbine plant shown in FIG. 1, the shutoff valve 301 and the flow control valve 302 are disposed in the inert gas supply system, and the shutoff valve 300 is disposed in the bypass line connecting the atomizing air supply system and the inert gas supply system to each other. Stated another way, the gas turbine plant according to the second embodiment has substantially the same construction as that shown in FIG. 1 except for that the cooling holes in the nozzle surface are omitted.

Further, as in the gas turbine plant shown in FIG. 1, the gas turbine plant according to the second embodiment can reduce the concentration of exhausted NOx by injecting the steam 104 into the combustion chamber after the liquid fuel 200 is burned and a load is applied. The fuel is changed over from the liquid fuel 200 to the gas fuel 201 with a subsequent increase of the load, and the supply of the atomizing air 103 is stopped after the shift to the gas combustion mode using only the mixed fuel. After the supply of the atomizing air 103 is stopped, the shutoff valve 300 is opened so that the steam 104 is injected from the center of the nozzle surface through the fuel nozzle 15 for startup. With the supply of the steam 104 to the combustion chamber through the fuel nozzle 15 for startup which is disposed at the center of the nozzle surface of the air swirler 17, the temperature of the flame formed near the nozzle surface lowers. As a result, the metal temperature at the nozzle surface can be reduced and the reliability can be improved.

Also, by utilizing the atomizing air supply system to supply the steam 104 to the fuel nozzle 15 for startup, there is no need of providing a new supply system which supplies the inert gas to the fuel nozzle 15 for startup. Another major advantage is as follows. Since it is general that the cooling holes for injecting fuel are not formed in the nozzle surface, the burner according to the second embodiment can be easily constructed by employing a known general burner adapted for the diffusive combustion system.

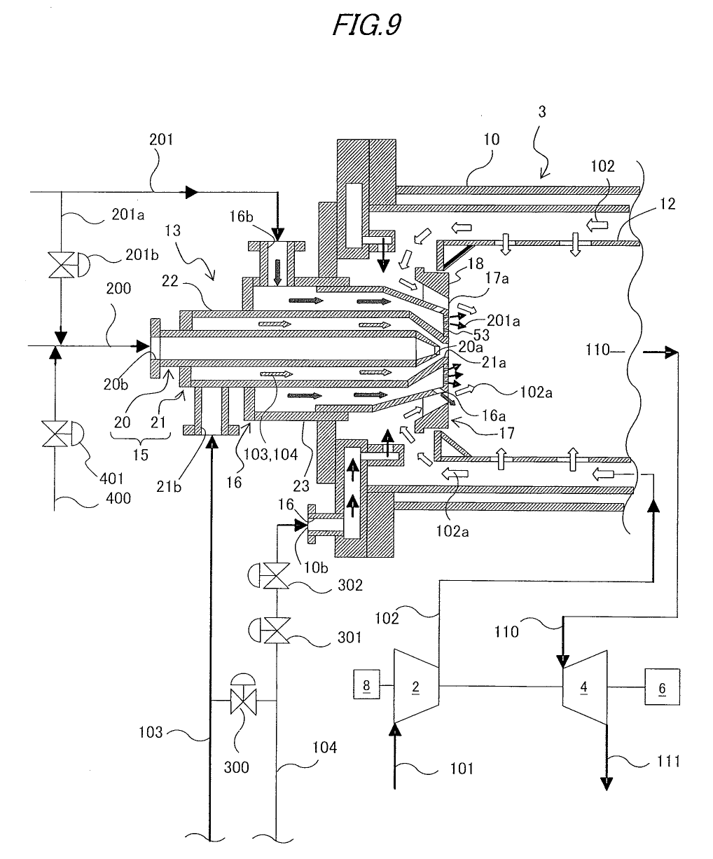

FIG. 9 is a schematic view of a gas turbine plant equipped with a burner according to a third embodiment of the present invention, the plant including a system for purging liquid fuel residing in a nozzle for startup.

In the first and second embodiments, the liquid fuel 200 is used for the startup of the gas turbine, and the supply of the liquid fuel 200 is stopped after the operating mode is shifted to the gas combustion mode using only the mixed fuel in a certain load condition. In such a process, if the liquid fuel 200 resides in the liquid fuel nozzle 20, there occurs a phenomenon (coking) that the liquid fuel nozzle 20 is heated by heat from the flame and the residing liquid fuel 200 is solidified in the nozzle. To avoid such a phenomenon, after completion of the shift to the gas combustion mode using only the mixed fuel, gas such as nitrogen is supplied to the liquid fuel nozzle 20 to purge the residing liquid fuel 200 into the combustion chamber, to thereby prevent the flow passage of the liquid fuel nozzle 20 being clogged by coking.

Also, after the operating mode is shifted from the gas combustion mode using only the mixed fuel (i.e., gas exclusive combustion) to the operation using only the liquid fuel for startup (i.e., oil exclusive combustion) and the gas turbine is stopped, a similar phenomenon may occur because the temperature in the combustor 3 is high. After the stop of the gas turbine, therefore, it is similarly required to purge the liquid fuel from the liquid fuel nozzle 20.

FIG. 9 shows, in enlarged scale, the burner including the fuel nozzle 15 for startup and the surroundings thereof. The gas turbine plant according to this third embodiment includes a nitrogen-supply purge system for supplying nitrogen 400 to the startup fuel supply system, and a gas-fuel-supply purge system 201a which is branched from the mixed fuel supply system and is used to supply a part of the gas fuel 201 to the startup fuel supply system. A shutoff valve 401 is disposed in the nitrogen-supply purge system, and a shutoff valve 201b is disposed in the gas-fuel-supply purge system 201a, respectively.

The operations for changing over fuel and purging the fuel for startup are as follows. When the load condition reaches a level adaptable for changeover to the gas fuel 201 after the startup using the liquid fuel 200, the fuel changing-over operation is performed by increasing the mass flow of the gas fuel 201 while reducing the mass flow of the liquid fuel 200 supplied to the liquid fuel nozzle 20 of the combustor. When the predetermined mass flow of the gas fuel 201 is supplied and the mass flow of the liquid fuel 200 is reduced to zero, the fuel changing-over operation is completed. At that time, if the liquid fuel 200 is left residing in the liquid fuel nozzle 20, coking occurs in the liquid fuel nozzle 20 by heat from the flame. Accordingly, the shutoff valve 401 for the nitrogen 400 is released to supply the nitrogen 400 to the liquid fuel nozzle 20, whereby the residing liquid fuel 200 can be purged into the combustion chamber and the occurrence of coking can be prevented. This purge system is intended to purge the liquid fuel. By continuously supplying the nitrogen 400 to the combustor 3 even after completion of the purge, the flame temperature near the swirler surface lowers, thus resulting in an advantage that the metal temperature at the swirler surface can be reduced during the gas combustion mode using only the mixed fuel (i.e., gas exclusive combustion).

Also, a similar advantage can be obtained when the residing liquid fuel is purged by supplying, to the liquid fuel nozzle 20, the part 201a of the gas fuel 201 which is branched from the mixed fuel supply system and introduced to the startup fuel supply system. Further, by so purging the liquid fuel 200 residing in the liquid fuel nozzle 20 into the combustion chamber and then continuously supplying the gas fuel to the combustion chamber even after completion of the purge, the fuel concentration near the swirler surface is enriched and the fuel rich region is formed. Accordingly, the flame temperature near the swirler surface lowers so that the metal temperature at the swirler surface can be reduced.

The cooling means in the above-described purge systems, i.e., the means for continuously supplying the nitrogen 400 and the part 201a of the gas fuel 201 through the liquid fuel nozzle 20 in the fuel nozzle 15 for startup during the gas combustion mode using only the mixed fuel (i.e., gas exclusive combustion), can be combined with the method for cooling the swirler surface in the first embodiment. As a result, the swirler surface can be effectively cooled even in the case of burning the fuel containing hydrogen, carbon monoxide, etc.

Additionally, as shown in FIG. 2, the swirler surface 18 has the injection port 21a through which the atomizing air is injected, the cooling holes 53 through which the gas fuel 201 is injected into the combustion chamber, and the flow passages 17a of the air swirler 17 through which the compressed air is supplied to the combustion chamber. Also, the injection ports for injecting the gas fuel and the atomizing air respectively from the mixed fuel nozzle 16 and the atomizing air nozzle 21 to the combustion chamber correspond to the nozzle surface in which those injection ports are formed.

As described above, the first to third embodiments include means for reducing the flame temperature in the vicinity of the air swirler, i.e., near the respective surfaces of the fuel nozzle 15 for startup and the mixed fuel nozzle 16 which are positioned to face the combustion chamber. As seen from FIG. 8, if the atomizing air 103 is supplied after the shift to the gas combustion mode using only the mixed fuel, there is a possibility that the metal temperature at the swirler surface rises and exceeds the melting point of the material forming the air swirler. For example, the melting point of SUS steel is 650° C. If the metal temperature exceeds that melting point, the air swirler 17 fails to develop the normal function due to burning-out of the swirler by the flame, or the burner can no longer maintain the flame due to clogging of the injection ports 16a of the mixed fuel nozzle 16, thus resulting in deterioration of reliability of the combustor. With the provision of the means for reducing the flame temperature near the swirler surface, which is positioned to face the combustion chamber, to be lower than the melting point of the swirler material, it is possible to prevent the burning-out of the swirler material, and to improve the reliability of the combustor.

Also, the first to third embodiments are useful in modifying the existing burners. For example, when the existing burners employ LNG (liquefied natural gas), gas oil, and A-heavy oil, change in the kind of used fuel can be adapted with a simple modification.

More specifically, the first and second embodiments are useful in modifying the existing burners in the following point. Supposing, for example, the case where the existing burner includes the fuel nozzle 15 for startup and the mixed fuel nozzle 16 and uses the liquid fuel in the fuel nozzle 15 for startup, it is thought that the relevant burner includes the atomizing air supply system for atomizing the liquid fuel. Therefore, the metal temperature in the vicinity of the air swirler can be reduced by just modifying the relevant burner such that the inert gas can be supplied to the atomizing gas supply system upstream of the atomizing air nozzle 21.

In addition, the metal temperature in the vicinity of the air swirler can be further reduced by replacing the nozzle surface (swirler surface) 18 of the burner 13, which is positioned to face the combustion chamber, with the nozzle surface having the cooling holes 53 formed therein. However, because the replacement of the nozzle surface requires the burner to be disassembled from the combustor, it is easier to carry out a modification such that the inert gas is supplied to the atomizing gas supply system, without disassembling the burner from the combustor.

Further, the third embodiment is also useful in modifying the existing burners. Namely, a similar advantage to that in the third embodiment can be obtained just by adding the purge system for supplying the nitrogen 400 to the startup fuel supply system in order to purge the liquid fuel 200 residing in the liquid fuel nozzle 20. However, the supply of nitrogen 400 requires auxiliary equipment, thus resulting in an increased plant size. To avoid such a drawback, the mixed fuel supply system is branched to additionally provide the gas-fuel-supply purge system 201a so that a part of the gas fuel 201 is supplied to the startup fuel supply system. With that modification, the delivery pressure of a gas compressor disposed in the existing mixed fuel supply system for supplying the mixed fuel to the burner can also be utilized to supply the part of the gas fuel 201 through the gas-fuel-supply purge system 201a, whereby the plant equipment can be downsized.

What is claimed is:

1. A burner for injecting mixed fuel containing at least one of hydrogen and carbon monoxide into a combustion chamber of a gas turbine combustor, said burner comprising:
a fuel nozzle for startup from which fuel for startup is injected into said combustion chamber;
a mixed fuel nozzle disposed around said fuel nozzle for startup and injecting the mixed fuel;
an air swirler disposed at a downstream end of said mixed fuel nozzle positioned in said combustion chamber and having a plurality of flow passages through which a part of compressed air from a compressor is injected into said combustion chamber to hold a flame, said mixed fuel nozzle having injection ports disposed in the inner peripheral side of the flow passages of said air swirler; and
cooling holes formed in a nozzle surface positioned to face said combustion chamber and introducing a part of the mixed fuel injected from said mixed fuel nozzle into said combustion chamber, to thereby reduce flame temperature near the nozzle surface.

2. The burner according to claim 1, wherein said fuel nozzle for startup comprises a liquid fuel nozzle for injecting liquid fuel for the startup of said gas turbine, and an atomizing air nozzle disposed around said liquid fuel nozzle and injecting atomizing air to atomize the liquid fuel.

3. The burner according to claim 1, wherein said fuel nozzle for startup is disposed at a center of a combustion liner forming said combustion chamber in the radial direction.

4. The burner according to claim 1, further comprising an inert gas supply system for supplying inert gas to said fuel nozzle for startup, wherein the inert gas from said inert gas supply system is supplied to said fuel nozzle for startup such that the inert gas is injected to the vicinity of the nozzle surface from said fuel nozzle for startup during a gas combustion mode using only the mixed fuel.

5. The burner according to claim 1, wherein the mixed fuel is any of coke oven gas, blast furnace gas, LD gas, coal, and heavy oil gasification gas.

6. A gas turbine combustor for burning mixed fuel containing at least one of hydrogen and carbon monoxide, said combustor comprising:
an outer casing serving as a pressure vessel;
a combustion liner disposed inside said outer casing and forming a combustion chamber therein;
a burner for forming a flame in said combustion chamber within said combustion liner; and
a transition piece for introducing, to a turbine, burned gas generated with the formation of the flame by said burner,
said burner comprising:
a fuel nozzle for startup from which fuel for startup is injected into said combustion chamber;
a mixed fuel nozzle disposed around said fuel nozzle for startup and injecting the mixed fuel;
an air swirler disposed at a downstream end of said mixed fuel nozzle positioned in said combustion chamber and having a plurality of flow passages through which a part of compressed air from a compressor is injected into said combustion chamber to hold a flame, said mixed fuel nozzle having injection ports disposed in the inner peripheral side of the flow passages of said air swirler; and
cooling holes formed in a nozzle surface positioned to face said combustion chamber and introducing a part of the mixed fuel injected from said mixed fuel nozzle into said combustion chamber, to thereby reduce flame temperature near the nozzle surface.

7. A burner for injecting mixed fuel containing at least one of hydrogen and carbon monoxide into a combustion chamber of a gas turbine combustor, said burner comprising:
a fuel nozzle for startup from which fuel for startup is injected into said combustion chamber;
a mixed fuel nozzle disposed around said fuel nozzle for startup and injecting the mixed fuel;
an air swirler disposed at a downstream end of said mixed fuel nozzle positioned in said combustion chamber and having a plurality of flow passages through which a part of compressed air from a compressor is injected into said combustion chamber to hold a flame, said mixed fuel nozzle having injection ports disposed in the inner peripheral side of the flow passages of said air swirler; and
means for purging the fuel residing in said fuel nozzle for startup.

8. The burner according to claim 7, wherein said means for purging the fuel includes a system for supplying a part of the mixed fuel, which is supplied to said mixed fuel nozzle, to said fuel nozzle for startup.
